(19) United States
(12) Patent Application Publication
(10) Pub. No.: US 2017/0107119 A1
(43) Pub. Date: Apr. 20, 2017

(54) FILTERING DEVICE, PLEATED FILTER, AND METHOD FOR TREATING BALLAST WATER

(71) Applicant: SUMITOMO ELECTRIC INDUSTRIES, LTD., Osaka-shi, Osaka (JP)

(72) Inventors: Shinichi KANAZAWA, Osaka (JP); Satoshi YAHAGI, Osaka (JP)

(73) Assignee: SUMITOMO ELECTRIC INDUSTRIES, LTD., Osaka-shi, Osaka (JP)

(21) Appl. No.: 15/318,048

(22) PCT Filed: Jan. 12, 2016
(86) PCT No.: PCT/JP2016/050650

§ 371 Date: Dec. 12, 2016

(30) Foreign Application Priority Data
Apr. 30, 2015 (JP) 2015-092497

(51) Int. Cl. C02F 1/00; B01D 33/72; B63J 4/00; B01D 33/27

(52) U.S. Cl. CPC C02F 1/004; B01D 33/27; B01D 33/72; B63J 4/002; C02F 2103/008

(57) ABSTRACT

A filtering device includes a pleated filter that includes a filter base having folds that repeatedly form mountains and valleys and having a cylindrical shape whose direction of an axis is a ridge line direction of the folds and in which the mountains are located outward in a radial direction, an untreated-water nozzle through which untreated water is ejected toward an outer circumferential surface of the pleated filter, a case that includes an outer tubular portion provided so as to surround the pleated filter and including a nozzle opening of the untreated-water nozzle therein, a filtered-water flow path that leads filtered water having passed through the pleated filter from the inside of the cylinder of the pleated filter to the outside of the case, and a discharge flow path through which discharge water that is not filtered by the pleated filter is discharged to the outside of the case. The pleated filter is configured to rotate in a direction about the axis. Ridge lines of the plural mountains of the pleated filter are curved in a shape that expands in a direction opposite to the rotation direction.

### TECHNICAL FIELD

The present invention relates to a structure of a filtering device using a pleated filter and a ballast water treatment method using the filtering device.

### BACKGROUND ART

In recent years, treatment of ballast water carried in ships has become an issue. Ballast water is seawater carried in a ship to provide safe voyage even when the ship is empty of cargo. Various methods for removing, killing, or inactivating microbes by purifying ballast water have been developed. Methods using filtration for the purpose of removing relatively large microbes have also been developed. For example, PTL 1 describes a ballast water treatment device using a filter membrane, the device being filed by the applicant of the present invention.

The applicant has developed a cylindrically shaped, pleated filter as a filter membrane used in the ballast water treatment device. PTL 2 discloses, as means for suppressing breakage of a pleated filter and using the pleated filter for a long time, a structure of a pleated filter provided with reinforcing sheets.

### CITATION LIST

### Patent Literature

PTL 1: Japanese Patent No. 4835785

PTL 2: Japanese Unexamined Patent Application Publication No. 2014-188484

### SUMMARY OF INVENTION

### Technical Problem

A device disclosed in PTL 2 is a filtering device in which a cylindrical pleated filter is installed in a tubular case and a liquid that is allowed to flow from the outside to the inside of the filter is collected as a filtrate. A liquid to be filtered, that is, an unfiltered liquid, is ejected from a nozzle provided on a side surface of the tubular case onto a part of a filtering surface of the filter. Consequently, filtered products deposited on a surface of the filter are washed to recover the permeation flux, and the filtered products that have been washed out are discharged from a filtration front chamber. With this structure, a stable filtration state is continuously maintained. An important factor for stably maintaining continuous filtration of such a system is the cleaning effect obtained by ejecting the unfiltered liquid onto the filtering surface of the filter. A cleaning region of the filter is changed with time so that the entirety of the filter is cleaned. In order to efficiently and effectively perform this cleaning, the cylindrical pleated filter is rotated during filtration by driving a motor or the like. In order to reliably perform this rotation cleaning and to stably maintain a high filtration flow rate, the ejection of the unfiltered liquid from the nozzle needs to be maintained at a certain high flow rate level or more. However, as a result of being subjected to the ejection of the unfiltered liquid at such a high flow rate, pleats are opened up and closed repeatedly. Consequently, the filter degrades with time and damaged, and part of the unfiltered liquid may be mixed directly with the filtrate without passing through the filter.

Accordingly, an object of the present invention is to provide a pleated filter whose degradation and damage due to use are prevented and which can be stably used for a long time, and a filtering device using the pleated filter.

### Solution to Problem

As a result of intensive studies on degradation of a filter, the inventors of the present invention found that a particular damage mode is generated in a filter that has been subjected to ejection of an unfiltered liquid at a high flow rate, and arrived at the following configuration as means for preventing the damage mode.

Specifically, a filtering device according to an embodiment of the present invention includes a pleated filter that includes a filter base having folds that repeatedly form mountains and valleys and having a cylindrical shape whose direction of an axis is a ridge line direction of the folds and in which the mountains are located outward in a radial direction, an untreated-water nozzle through which untreated water is ejected toward an outer circumferential surface of the pleated filter, a case that includes an outer tubular portion provided so as to surround the pleated filter and including a nozzle opening of the untreated-water nozzle therein, a filtered-water flow path that leads filtered water having passed through the pleated filter from the inside of the cylinder of the pleated filter to the outside of the case, and a discharge flow path through which discharge water that is not filtered by the pleated filter is discharged to the outside of the case. The pleated filter is configured to rotate in a direction about the axis. Ridge lines of the plural mountains of the pleated filter are curved in a shape that expands in a direction opposite to the rotation direction.

### Advantageous Effects of Invention

According to the above configuration, it is possible to provide a pleated filter whose damage due to use is prevented, thereby contributing to stable use for a long time, and a filtering device using the pleated filter, and to provide a ballast water treatment method in which the filtering device is used as a ballast water treatment device.

### BRIEF DESCRIPTION OF DRAWINGS

FIG. 1 is a perspective schematic view illustrating a basic structure of a pleated filter.

FIG. 2 is a view illustrating an example of a filtering device according to an embodiment of the present invention and is a sectional schematic view illustrating the structure of a vertical section including an axis line.

FIG. 3 is a schematic view illustrating the structure of a horizontal A-A section in the filtering device of FIG. 2.

FIG. 4 is an enlarged schematic view of a part of a side surface of a pleated filter and is a view illustrating a state in which pleats are curved in the right direction.

FIG. 5 is an enlarged schematic view of a part of a side surface of a pleated filter and is a view illustrating a state in which pleats are curved in the left direction.

FIG. 6 is a view illustrating the degree of curvature of a pleat.

FIG. 7 is an enlarged schematic view illustrating the positional relationship between a pleated filter and an untreated-water nozzle that are illustrated in FIG. 3.

FIG. 8 is a view illustrating a state in which pleats are opened up by ejection of untreated water in FIG. 7.

FIG. 9 is a view illustrating a state of FIG. 7 viewed from a side surface.

FIG. 10 is a schematic view illustrating a state in which the pleated filter in FIG. 4 is opened up by untreated water.

FIG. 11 is a schematic view illustrating a state in which the pleated filter in FIG. 5 is opened up by untreated water.

FIG. 12 is a block diagram illustrating an example of the overall structure of a ballast water treatment system using a ballast water treatment device according to an embodiment of the present invention.

### REFERENCE SIGNS LIST

10, 101 pleated filter

11 filter base

41 pump

42 filtering device

43 sterilization device

44 tank

31, 32, 33, 34, 35 pipe

102 untreated-water nozzle

103 case

104, 105 lid member

106 untreated-water flow path

107 filtered water flow path

108 discharge flow path

121 nozzle opening

131 outer tubular portion

132 lid portion

133 bottom portion

140 central pipe

141 water intake hole

190 motor

### DESCRIPTION OF EMBODIMENTS

### Description of Embodiments of Present Invention

Structures of a pleated filter and a filtering device according to embodiments of the present invention, the filtering device using the pleated filter as a filter membrane, will be described below with reference to the drawings. The scope of the present invention is not limited to these embodiments but is defined by the claims described below. It is intended that the scope of the present invention includes equivalents of the claims and all modifications within the scope of the claims.

An embodiment disclosed in the present invention is a filtering device that includes a pleated filter that includes a filter base having folds that repeatedly form mountains and valleys and having a cylindrical shape whose direction of an axis is a ridge line direction of the folds and in which the mountains are located outward in a radial direction, an untreated-water nozzle through which untreated water is ejected toward an outer circumferential surface of the pleated filter, a case that includes an outer tubular portion provided so as to surround the pleated filter and including a nozzle opening of the untreated-water nozzle therein, a filtered-water flow path that leads filtered water having passed through the pleated filter from the inside of the cylinder of the pleated filter to the outside of the case, and a discharge flow path through which discharge water that is not filtered by the pleated filter is discharged to the outside of the case. The pleated filter is configured to rotate in a direction about the axis. Ridge lines of the plural mountains of the pleated filter are curved in a shape that expands in a direction opposite to the rotation direction.

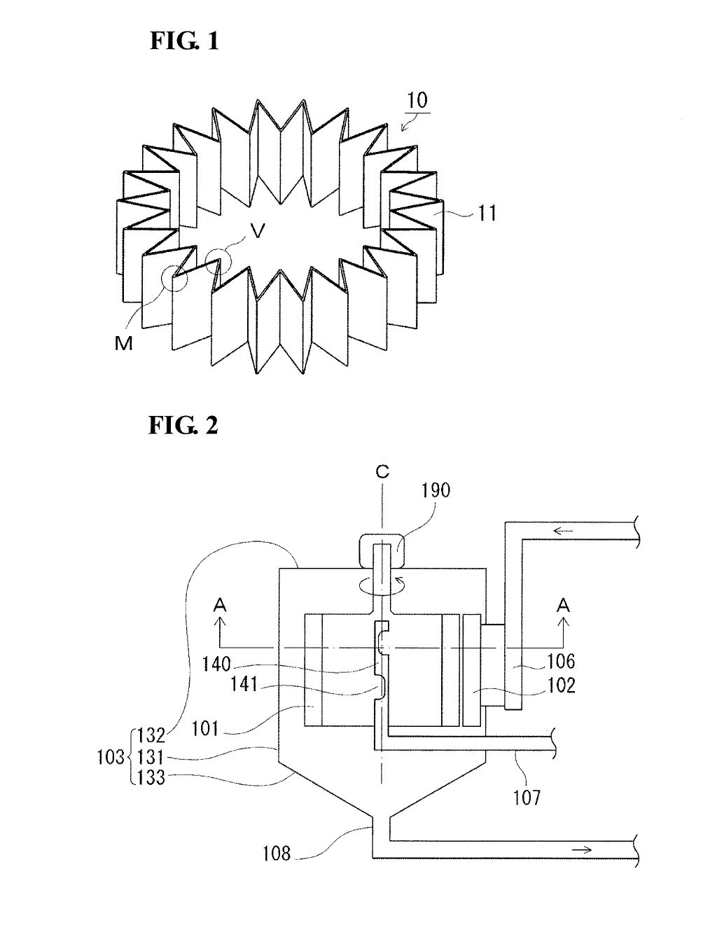

A basic structure of a cylindrically shaped, pleated filter will be described with reference to FIG. 1. FIG. 1 is a perspective view illustrating a pleated filter 10 having a cylindrical shape as a whole, the pleated filter 10 being obtained by repeatedly folding a strip-like filter base 11, subsequently connecting ends of the filter base 11 in a ring-shaped manner so that a ridge line direction of the resulting folds is an axial direction. Herein, in a state of a cylindrical shape, a fold located toward the outside of the cylinder (a fold in a portion M of the figure) is referred to as a mountain, and a fold located toward the inside of the cylinder (a fold in a portion V of the figure) is referred to as a valley. For the sake of easy understanding of a description, FIG. 1 illustrates an example in which the number of folds is small. However, in a pleated filter for practical use, the number of folds can be appropriately determined in accordance with the use. Similarly, the height of the pleated filter in the cylindrical axis direction, the distance between a mountain and a valley, and the like are also appropriately determined. In such a pleated filter for practical use, the folds do not have ideal acute angles as illustrated in the figure, but are often rounded folds.

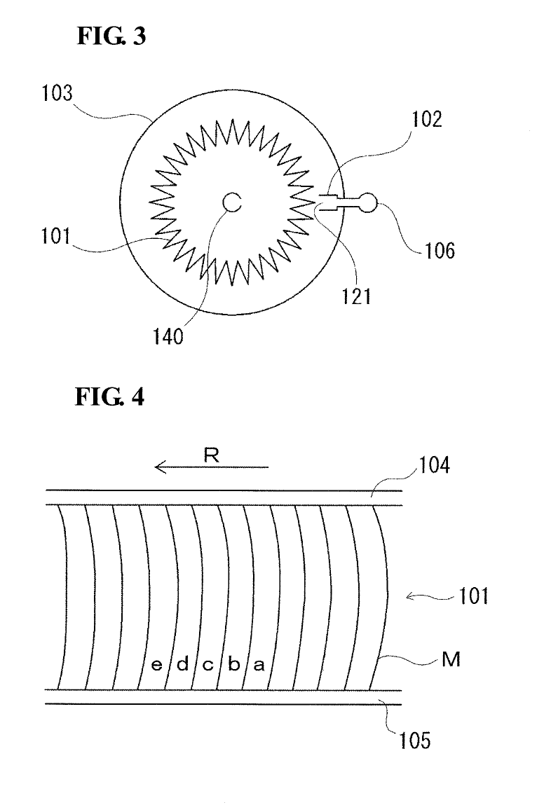

Next, an overall structure of a filtering device will be described with reference to FIGS. 2 and 3. FIGS. 2 and 3 are views illustrating an example of a filtering device according to an embodiment of the present invention. The filtering device is preferably used as a device for treating ballast water for ships. FIG. 2 is a schematic view illustrating the structure of a vertical section including an axis line of a cylinder of a pleated filter. FIG. 3 is a schematic view illustrating the structure of a horizontal A-A section in FIG. 2.

A cylindrically shaped, pleated filter 101 is disposed about an axis line, which is the center of rotation, and is mounted to be rotatable about a central pipe 140 arranged in the center (the pipe does not rotate). An upper surface and a lower surface of the pleated filter 101 are sealed with lid members, and the lid members are rotatable with respect to the axis. The rotatable attachment structure also needs to have a watertight structure. However, the attachment structure is not particularly limited, and a known structure may be used. A case 103 is provided so as to cover the whole filter. The case 103 includes an outer tubular portion 131, a lid portion 132, and a bottom portion 133. A discharge flow path 108 is provided on the bottom portion 133. An untreated-water flow path 106 and an untreated-water nozzle 102 are provided in order to introduce seawater as untreated water into the case 103. The untreated-water nozzle 102 is provided to extend from the untreated-water flow path 106 so as to have a nozzle opening 121 thereof in the outer tubular portion 131 of the case 103, and is configured so that the untreated water flows toward an outer circumferential surface of the pleated filter 101. A motor 190 is provided on the central axis of the pleated filter 101 for the purpose of the rotation of the pleated filter 101. The motor 190 is driven by an electric power supplied from a driving control unit (not illustrated). The motor 190 that is disposed directly on the central axis is an example of a driving device for rotation. The motor 190 may be replaced with another driving device.

In this embodiment, the untreated water ejected from the untreated-water nozzle 102 is applied to the outer circumferential surface of pleats of the pleated filter 101, and an effect of cleaning the pleated filter 101 is obtained by the pressure and flow of the untreated water. The untreated water that is not filtered and suspended substances settled in the case 103 are sequentially discharged through the discharge flow path 108 on the bottom portion 133 of the case. This point that filtration is performed while continuously and constantly discharging suspended substances and residual untreated water in this manner is also a feature of this device. For example, this feature is advantageous for reliably achieving a large amount of treatment of 50 to 100 ton/hour and, in a larger system, 4,000 ton/hour, which are required for a ballast water treatment. In such a large-sized filtering device that treats a large amount of water, the size of the pleated filter is large, and thus it is particularly important to prevent the breakage of the pleated filter. Although valves and other components are not illustrated in the discharge flow path 108 in the figure, devices necessary for maintenance and flow rate control may be provided. The filtered water filtered by the pleated filter 101 is guided to a filtered water flow path 107 through a water intake hole 141 provided in the central pipe 140 in the inside of the filter, and is discharged to the outside of the case.

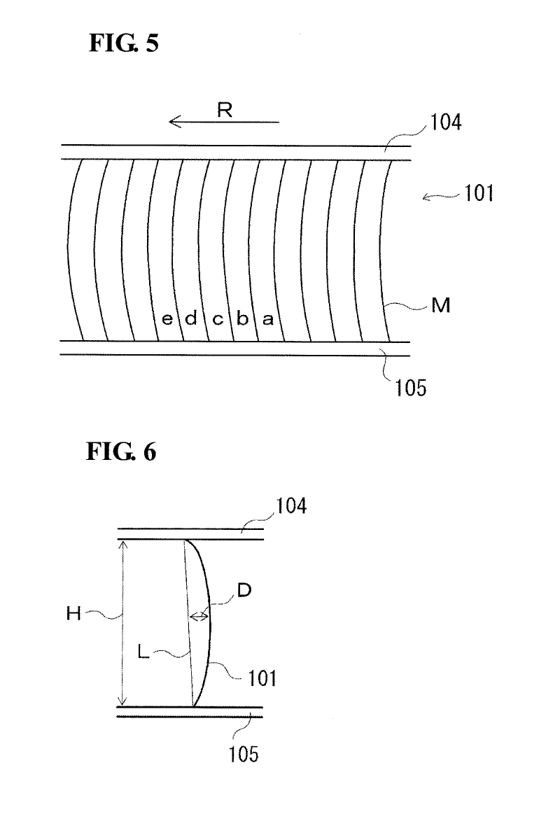

Next, the feature “ridge lines of a plurality of mountains of a pleated filter are curved in a shape that expands in a direction opposite to a rotation direction” will be described. FIGS. 4 and 5 each schematically illustrate a state of a pleated filter viewed from a side surface. In FIG. 4, a pleated filter 101 is sealed with an upper lid member 104 and a lower lid member 105 so that the shape of pleats thereof is fixed and liquid leakage does not occur between the inside and the outside of the pleated filter 101. Typically, the lid members 104 and 105 and the pleated filter 101 are fixed with a resin functioning as an adhesive. FIG. 4 illustrates a state in which ridge lines of mountains M of the pleated filter 101 are viewed from a side surface. Valleys are not illustrated in the figure. An arrow R indicates a direction in which the pleated filter 101 rotates. The untreated-water nozzle 102 is disposed so as to face the side surface of the pleated filter 101. Untreated water is ejected through the nozzle opening 121 toward the pleated filter 101. For the sake of description of the rotation direction, as illustrated in the figure, spaces between pleats are sequentially assigned with symbols a, b, c, d, and e. In this case, the flow of the untreated water is given in the order of e→d→c→b→a. The feature “ridge lines of a plurality of mountains are curved in a shape that expands in a direction opposite to the rotation direction” refers to a state in which central portions of folds of the pleated filter are curved so as to project toward the rotation direction, as illustrated in FIG. 4. The term “curvature” typically refers to a state in which folds are bent to form gentle curves in a certain direction. However, it is sufficient that the folds are curved so as to project in one direction as a whole. Specifically, each of the folds does not necessarily form a complete arched curve, but may include a change in the curvature or a linear portion to a certain degree. All the mountains are preferably curved in the same direction. However, all the mountains need not be necessarily curved in the same direction. It is not necessary that all the mountains be curved to have a uniform shape.

In contrast, FIG. 5 illustrates a pleated filter in which ridge lines of a plurality of mountains are curved in a shape that expands in the rotation direction. The symbols in the figure are the same as those in FIG. 4. Also in this case, the untreated water is supplied in the order of pleats e→d→c→b→a.

A magnitude of the curvature of a pleated filter preferably satisfies a relationship D/H>0.004 where D represents a distance between a straight line connecting two ends of a mountain and a central portion of the mountain, and H represents a direct distance between two ends of the mountain. When D/H≦0.004, an action by untreated water, which will be described below, becomes the same as that in the case of a reverse curvature, and the mountain becomes easily damaged. FIG. 6 is a view illustrating the definition of the magnitude of the curvature. FIG. 6 is a view illustrating only a single ridge line of a mountain of a pleated filter 101 fixed by an upper lid member 104 and a lower lid member 105. A distance between the upper lid member 104 and the lower lid member 105 is represented by H. The length of a perpendicular line drawn from an arbitrary point of the ridge line with respect to a straight line L connecting two fixed points of the ridge line of the mountain is determined, and the maximum of the length is represented by D. Herein, the ratio D/H is defined as the magnitude of the curvature. A pleated filter for practical use includes a large number of mountains. Accordingly, the ratio D/H is measured for 10% or more of the total number of mountains and at least 10 points or more of the mountains, and the average of the measured values is determined as the magnitude of the curvature of the pleated filter. The measurement can be performed by using, for example, photo-instrumentation from a side surface.

A porous resin sheet is used as the base of the filter. Examples of the base that can be used include porous structures such as a stretched porous body, a porous body by phase separation, and a non-woven cloth that are formed of a material such as polyester, nylon, polyethylene, polypropylene, polyurethane, polytetrafluoroethylene (PTFE), or polyvinylidene fluoride (PVdF). For the purpose of performing a treatment at a high flow rate, a non-woven cloth formed of a polyester such as polyethylene terephthalate is particularly suitably used. In particular, polyethylene terephthalate has a bulk strength higher than those of other general-purpose plastics. Accordingly, a polyethylene terephthalate non-woven cloth is not easily flattened by the pressure of filtration or a permeation flow, and obstruction of a flow or breakage of the filter does not easily occur. Therefore, a filter formed of a polyethylene terephthalate non-woven cloth is suitable for a filtering device used at a high filtration differential pressure or a high-flow rate filtering device used at a high permeation flow rate.

The pleated filter described in the above filtering device can be used as a filter membrane alone in the filtering device or, in many cases, as a pleated filter serving as a replacement member. Specifically, the pleated filter is a pleated filter used in a filtering device, in which when a side surface of a cylindrical shape is viewed from a direction perpendicular to an axis, ridge lines of the plural mountains are curved in one direction with respect to a straight line connecting two ends of each of the mountains. Furthermore, in view of convenience of, for example, replacement, the pleated filter is preferably handled as a pleated filter cartridge in which an upper end and a lower end of the pleated filter are sealed and integrated with lid members. The use of such a pleated filter in a filtering device can prevent damage due to use and can contribute to stable use of the pleated filter for a long time. The use of a pleated filter in the form of a pleated filter cartridge facilitates the replacement and achieves longer-term use of the filtering device.

It is possible to provide, as a method in which the pleated filter is used for filtration, a method for treating ballast water, the method including installing the filtering device in a hull; using, as untreated water, seawater taken from the outside of the hull; further applying a sterilization treatment to filtered water treated by the filtering device; and subsequently storing the resulting water in the hull as ballast water, and a system for treating ballast water.

FIG. 12 is a diagram that illustrates the overall structure of a system for treating ballast water for ships, in which the filtering device described above is used, and a method for treating ballast water. In FIG. 12, untreated water, which is seawater taken from the ocean, is fed through a pipe 31 with a pump 41 and is supplied to a filtering device 42, which is filtering means, through a pipe 32. Filtered water filtered in the filtering device 42 passes through a pipe 33 and is fed to a sterilization device 43 such as an ultraviolet irradiation device or an electrolytic device. Discharge water that has not been filtered in the filtering device 42 is led to the outside of the device through a pipe 35. The seawater that has been subjected to a sterilization treatment is fed to a tank 44 through a pipe 34 and is stored as ballast water.

By using the device or using the method, damage of a filter is reduced as compared with existing techniques, and the filtering device can be stably used for a long time without causing filtration defects. Consequently, the labor cost of maintenance and the cost of materials to be replaced can be reduced, and the production of ballast water can be further facilitated.

### Damage Mode of Pleated Filter

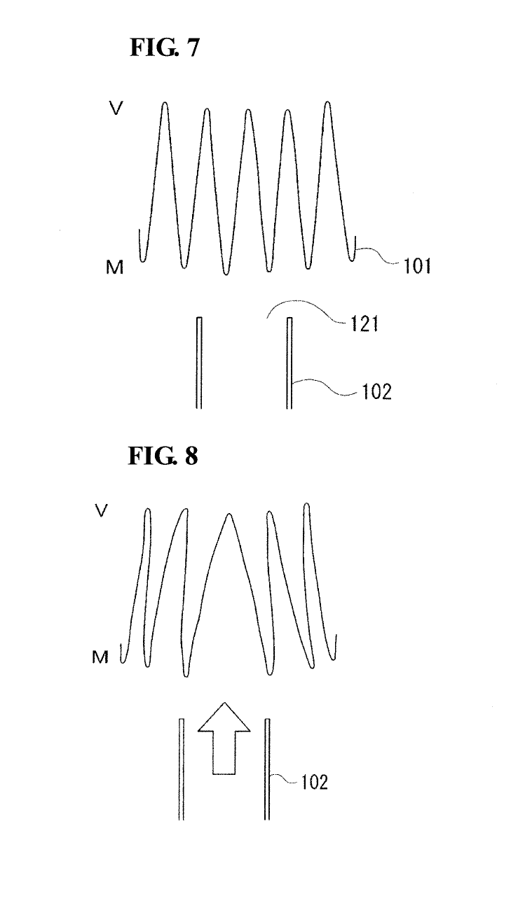

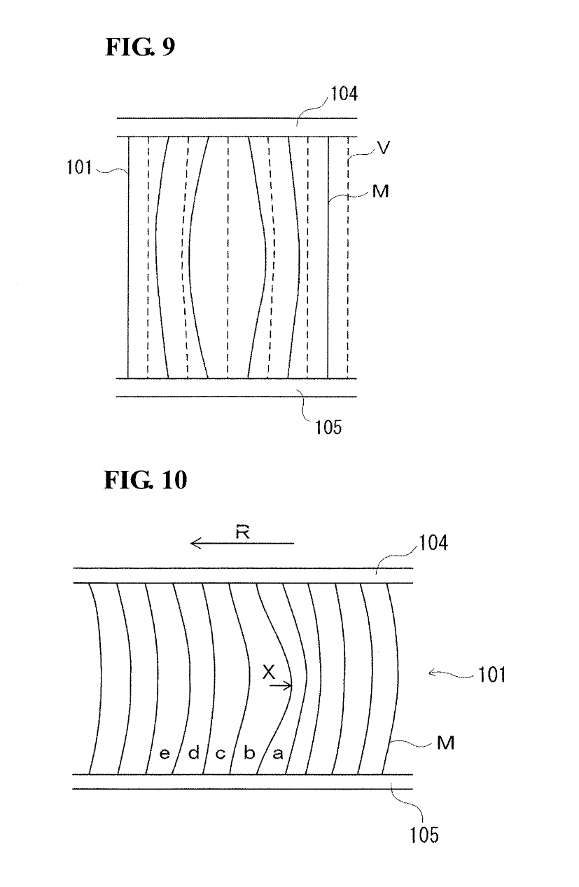

The relationship between damage of a pleated filter and a curvature thereof will be described with reference to FIGS. 7 to 11. Again with reference to FIGS. 2 and 3, in the filtering device, the cylindrical pleated filter 101 is used for performing filtration from the outside toward the inside of the cylinder while rotating in the case 103. An outer surface of the filter is cleaned by causing untreated water ejected through the nozzle opening 121 to flow. FIG. 7 is an enlarged schematic view of a horizontal section of a part in which the pleated filter 101 faces the untreated-water nozzle 102 as described above. In FIG. 7, reference character M indicates a mountain located toward the outside of the pleated filter 101, and reference character V indicates a valley located toward the inside of the pleated filter 101. Referring to FIG. 8, when untreated water is ejected through the nozzle opening 121 of the untreated-water nozzle 102 as illustrated in the thick arrow, the pleated filter 101 is opened by the untreated water. FIG. 9 is a schematic view of this state viewed from a side surface of the pleated filter. In FIG. 9, the solid lines indicate mountains M, and the dotted lines indicates valleys V. The upper end and the lower end of the pleated filter 101 are fixed by lid members 104 and 105, respectively. Therefore, when untreated water flows in a space between pleats, a central portion of the pleated filter 101 significantly opens and portions near the upper and lower ends of the pleated filter 101 only slightly open.

The inventors of the present invention found that, in the case where pleats of a pleated filter are not straight but curved, the way pleats open differs depending on the direction of the curvature. In general, a pleated filter is produced such that folds of the pleated filter become straight. However, when the folds are formed in the production process, a curvature in a certain direction is often generated in the folds due to, for example, unevenness of force applied to the filter base and the direction in which the force is applied. In a step of producing a typical cylindrical pleated filter, first, a strip-like filter base is repeatedly folded to a uniform width, and two ends of the filter base are then connected to each other to form a ring shape, thus forming the cylindrical pleated filter. In this folding step, a crushing force is applied in a particular direction. As a result, a curvature in one direction, a so-called curving tendency, is applied over the entirety of the folds. By forming this filter base so as to have a ring shape, a curvature of the folds in one direction is generated across the circumferential direction. The curvature can be formed by using such a curving tendency. Alternatively, a curvature may be intentionally foamed by, for example, using a curved pattern when folding a filter base. The method for forming a curvature is not particularly limited.

The behavior of a pleated filter with respect to a direction of the curvature will be described. The behavior described below was newly found by the inventors as a result of an image analysis of the movement of a filtering device for practical use. As described above, when untreated water flows toward mountains of pleats, the pleats are opened up as illustrated in FIG. 9. FIG. 10 illustrates a state in the case where the direction of curvatures of mountains forms a shape that expands in a direction opposite to a rotation direction.

FIG. 10 illustrates deformations of a plurality of pleats at a certain moment. However, FIG. 10 can also be regarded to sequentially illustrate a deformation of a certain space between pleats in time series. Specifically, at this moment, spaces expanded by the inflow of the untreated water are spaces b and c. A space d illustrates a state after a moment of the state of the space c, and a space e illustrates a state after the state of the space d. In contrast, the space b illustrates a state before a moment of the state of the space c, and a space a illustrates a deformed state before the state of the space b. More specifically, each space between pleats is deformed while passing through an inflow portion of the untreated water in the order of e→d→c→b→a, and the state of the deformation of a certain space between pleats changes in the order of a→b→c→d→c. Next, a deformation of a mountain M that is damaged by the deformation will be assumed. The mountain M deforms most significantly at the moment of the space b, which is expanded most significantly. In the case where the direction of curvatures of mountains forms a shape that expands in the direction opposite to the rotation direction as illustrated in FIG. 10, the mountain M deforms in such a manner that the curvature returns from the most significantly curved state on the right side of the space b to the original state on the left side of the space b.

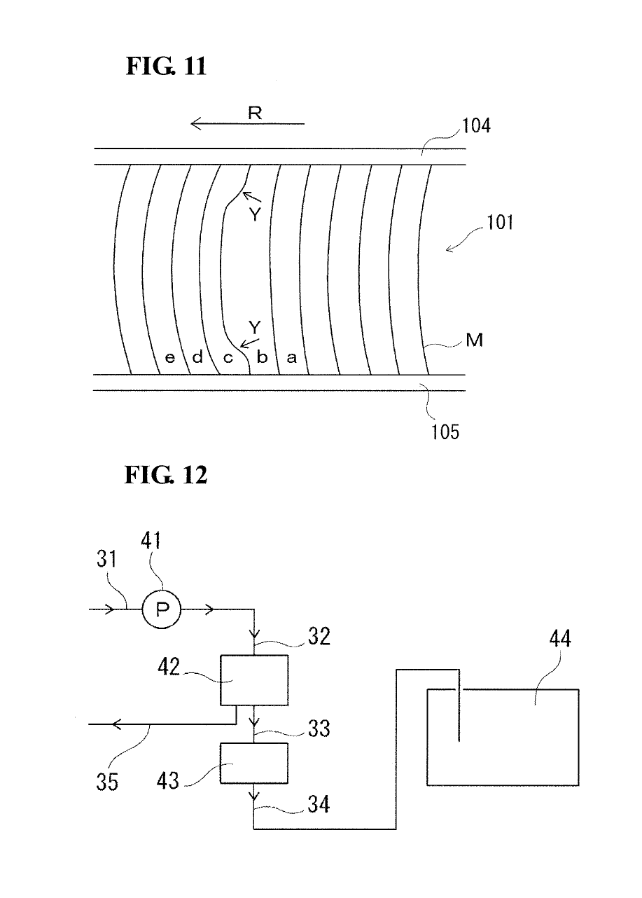

Next, the case where the direction of curvatures forms a shape that expands in a rotation direction R will be described with reference to FIG. 11. The reference characters are the same as those in FIG. 10. In FIG. 11, a space expanded by the inflow of the untreated water is a space b. The deformation of a mountain M changes from the right side of the space b to the right side of a space c, and then to the mountain on the left side of the space c. In the case where the direction of curvatures of mountains forms a shape that expands in the rotation direction as described above, the deformation occurs in such a manner that the curvature changes from the original state to the most significantly curved state, which is reverse to the case illustrated in FIG. 10. More specifically, in the case illustrated in FIG. 10, the maximum deformation occurs in a direction in which the curvature deformation is relieved. In contrast, in the case illustrated in FIG. 11, the deformation occurs in a direction in which the curvature deformation becomes significant, and thus damage of the deformation on the mountain M increases.

This difference in deformation also affects the position at which damage occurs. In the case illustrated in FIG. 10, the mountains M are curved so as to expand in the direction opposite to the rotation direction R. Accordingly, as a result of the inflow of the untreated water, a mountain M deforms in a direction in which a portion near the center of the mountain (a portion X indicated by the arrow in the figure) particularly projects. It is believed that this is due to the direction of the curvature and a change in opening up and closing of the pleats as a result of a change in the inflow pressure of the untreated water in the order of e→d→c→b→a in the figure. In contrast, in the case illustrated in FIG. 11, a mountain is significantly curved in portions near the upper and lower ends of the mountain (portions Y indicated by the arrows in the figure). In this manner, the position at which the deformation of a mountain of a pleat concentrates varies depending on the relationship between the direction of the curvature and the direction of the rotation. Therefore, the difference in damage mode is generated in a mountain of the filter base. When the direction of the curvature of a mountain forms a shape that expands in the direction opposite to the rotation direction, the damage in the mountain is easily generated in a central portion of the mountain. On the other hand, when the direction of the curvature of a mountain forms a shape that expands in the rotation direction, the damage in the mountain is easily generated in portions near the upper and lower ends of the mountain.

### Experimental Example

In order to verify the difference in filter damage due to the direction of the curvature, a plurality of pleated filters were prepared and installed in a filtering device, and a filtration experiment was performed. Each of the pleated filters used has an outer diameter (diameter of the circumference of mountains of a cylinder) of 700 mm, a length in the axial direction of 378 mm, a pleats depth of 70 mm, and a number of pleats of 450. The operation was performed under the conditions of a jet-flow flux of 6.9 m/sec, a filtration flow rate of 71.7 m³/hour, and a discharge water flow rate of 14.3 m³/hour. A filter base used was a polyethylene terephthalate non-woven cloth (trade name: AXTAR™ G2260-1 S BK0, manufactured by Toray Industries, Inc.). Mountains and valleys of the filter base were reinforced with a resin.

A plurality of pleated filters having the same size were prepared. The degree of curvature of each of the pleated filters was measured before and after the filtration. The degree of curvature was determined by taking a photograph of the pleated filter from a side surface thereof, and measuring the resulting image. In this experiment, the entire height of the pleats, that is, the distance H between an upper lid member and a lower lid member is uniform and is 378 mm. The maximum length of a perpendicular line drawn from an arbitrary point of a ridge line of a mountain with respect to a straight line connecting two fixed points of the ridge line of the mountain was determined as H. The ratio D/H was represented in terms of percentage and defined as the magnitude of the curvature. The magnitude of the curvature was measured as described above at arbitrary 10 points selected from all the mountains, and the average thereof was determined. Table 1 shows the direction of curvature, the amount D of curvature, and the magnitude of the curvature of each of the samples used. When the ridge line is curved so as to expand in a direction opposite to a rotation direction of the cylinder, the curvature direction is denoted by “opposite”. When the ridge line is curved so as to expand in the rotation direction, the curvature direction is denoted by “normal”. The amount of curvature was determined by the same method before filtration (initial) and after filtration (after evaluation) of the filtration experiment.

TABLE 1

| | | Amount of | | Magnitude of | | |
|---|---|---|---|---|---|---|
| | | curvature (mm) | | curvature (%) | | Damage |
| Test | Curvature | | After | | After | time |
| number | direction | Initial | evaluation | Initial | evaluation | (hour) |
| R1 | Opposite | 1.5 | 5.0 | 0.40 | 1.3 | >156 |
| R2 | Opposite | 1.9 | 4.0 | 0.50 | 1.1 | >138 |
| R3 | Opposite | 2.3 | 5.0 | 0.61 | 1.3 | >158 |
| R4 | Opposite | 2.4 | 6.0 | 0.63 | 1.6 | >138 |
| R5 | Opposite | 2.8 | 4.0 | 0.74 | 1.1 | >136 |
| R6 | Opposite | 3.0 | 3.0 | 0.79 | 0.79 | 210 |
| R7 | Opposite | 3.1 | 6.0 | 0.82 | 1.6 | 215 |
| R8 | Opposite | 3.8 | 6.5 | 1.0 | 1.7 | >158 |
| R9 | Opposite | 4.7 | 4.0 | 1.2 | 1.1 | 215 |
| L1 | Normal | −1.2 | −3.0 | −0.32 | −0.79 | 130 |
| L2 | Normal | −1.8 | −4.0 | −0.48 | −1.1 | 133 |
| L3 | Normal | −2.9 | −7.0 | −0.77 | −1.9 | 120 |
| L4 | Normal | −3.2 | −3.0 | −0.85 | −0.79 | 130 |
| L5 | Normal | −3.2 | −5.0 | −0.85 | −1.3 | 100 |

A filtration operation was performed for a long time using the 14 pleated filters. The occurrence or nonoccurrence of damage was examined. When damage occurred, the time period until the damage occurred was measured. The samples having a curvature in the normal direction were represented by Test numbers R1 to R9, and the samples having a curvature in the opposite direction were represented by Test numbers L1 to L5. The column of damage time in Table 1 shows the occurrence or nonoccurrence of damage and the time period until the damage occurred. The occurrence or nonoccurrence of damage was examined as follows. Whether or not suspended substances permeated without being filtered was detected by monitoring the turbidity of filtered water. When such permeation was detected, the operation was stopped, and the damaged position was visually observed. The time shown in the table means that, at the time when the time period elapsed, damage occurred in a mountain. The notation of the damage time with a sign of inequality (for example, “>138”) represents that no damage in a mountain was observed when the operation was continued up to the time. Such a notation includes a case where the operation was stopped because of other factors and a case where the operation was stopped because of damage at a position other than a mountain.

In each of Test numbers L1 to L5, damage occurred in a mountain during the operation for 133 hours at the longest. In contrast, in each of Test numbers R1 to R9, no damage occurred during the operation for more than 136 hours. The results of R6, R7, and R9 show that an operation for about 210 hours can be realized. It was confirmed that the filter lifetime due to damage in a mountain significantly differs depending on the direction of the curvature. Furthermore, the mountains in which the damage occurred were observed. According to the results, in each of Test numbers R6, R7, and R9, a small splitting in the circumferential direction (direction perpendicular to the axis) was observed near a central portion between the upper and lower ends of a ridge line of a mountain. In contrast, in each of Test numbers L1 to L5, a small splitting in the circumferential direction (direction perpendicular to the axis) was observed near a fixed portion of a ridge line of a mountain.

### INDUSTRIAL APPLICABILITY

According to the filtering device of the present invention, a decrease in the performance due to damage does not occur, and the filtering device has good durability. Accordingly, the filtering device of the present invention is suitable for use in preliminary filtration treatment for removing foreign matter, contaminants, and microbes in water in the cases of seawater desalination, the use of brackish water/seawater for purposes such as ballast water, or the treatment of water such as sewage water, human sewage, industrial waste water, or the like. Furthermore, the filtering device of the present invention is suitable for the treatment of water having a high suspended substance/high SS (suspended solid) content and a concentration treatment, and thus can also be used in the field of collection of valuable recyclable materials, for example, in the field of food.

1. A filtering device comprising a pleated filter that includes a filter base having folds that repeatedly form mountains and valleys and having a cylindrical shape whose direction of an axis is a ridge line direction of the folds and in which the mountains are located outward in a radial direction;
an untreated-water nozzle through which untreated water is ejected toward an outer circumferential surface of the pleated filter; a case that includes an outer tubular portion provided so as to surround the pleated filter and including a nozzle opening of the untreated-water nozzle therein; a filtered-water flow path that leads filtered water having passed through the pleated filter from the inside of the cylinder of the pleated filter to the outside of the case; and a discharge flow path through which discharge water that is not filtered by the pleated filter is discharged to the outside of the case,
wherein the pleated filter is configured to rotate in a direction about the axis, and ridge lines of the plural mountains of the pleated filter are curved in a shape that expands in a direction opposite to the rotation direction.

2. The filtering device according to claim 1, wherein a magnitude of the curvature satisfies a relationship D/H>0.004 where D represents a distance between a straight line connecting two ends of a mountain and a central portion of the mountain, and H represents a direct distance between two ends of the mountain.

3. The filtering device according to claim 1, wherein the filter base is a polyethylene terephthalate non-woven cloth.

4. A pleated filter used in the filtering device according to claim 1,
wherein when a side surface of the cylindrical shape is viewed from a direction perpendicular to the axis, ridge lines of the plural mountains are curved in one direction with respect to a straight line connecting two ends of each of the mountains.

5. A method for treating ballast water, the method comprising installing the filtering device according to claim 1 in a hull; using, as untreated water, seawater taken from the outside of the hull; further applying a sterilization treatment to filtered water treated by the filtering device; and subsequently storing the resulting water in the hull as ballast water.
